(19) United States
(12) Patent Application Publication
(10) Pub. No.: US 2003/0101199 A1
(43) Pub. Date: May 29, 2003

(54) Electronic document processing system

(75) Inventor: Lawrence John Briggi, Croton, NY (US)

Correspondence Address: Donald J. Lenkszus, PC, PO Box 3064, Carefree, AZ, 85377-3064, US

(73) Assignee: PLANET DATA SOLUTIONS, INC. A New York Corporation, Tarrytown, NY

(21) Appl. No.: 09/995,412

(22) Filed: Nov. 27, 2001

(51) Int. Cl. G06F 12/00

(52) U.S. Cl. 707/200

(57) ABSTRACT

An electronic document management system automatically scanning a batch of related documents separated into a plurality of document groupings. A workstation automatically separates the batch of scanned documents into separate documents. A workstation display provides a display of information for each document. An operator identifies portions of information to selectively scan to provide document indexing information and to obtain text based captured information from each document. The text based captured information is used to create an image file for each document and a text file for the batch. The text file comprises the text based captured information and references to each image file. The text file is used to control loading of data relating to the documents into a database and control transfer of the image file for each document into one or both of the file storage and the database. An e-mail is sent to a predetermined group of users to identify scanned and stored documents. The e-mail includes links to the specific documents.

### FIELD OF THE INVENTION

This invention pertains to electronic document processing systems, in general, and to an electronic document processing system for law firms, in particular.

### BACKGROUND OF THE INVENTION

The processing of large volumes of paper electronically is of increasing importance. Law firms in particular must process extremely large volumes of material for litigation and other matters in a way that leads to efficient optical scanning of the documents as well as retrieval. In the past scanner systems have been available that provide for batch scanning of documents. However, such systems are limited in the ability to provide for rapid notification to system users of the availability of scanned documents and ease of retrieval by users of such documents.

### SUMMARY OF THE INVENTION

In accordance with the principles of the invention, an electronic document management system comprises a document receiving system portion, a document processing system portion, and a document accessing portion. The document receiving portion comprises a scanner and a workstation. The scanner automatically scanning a batch of related documents separated into a plurality of document groupings. The workstation receives scan data from the scanner and automatically separates the batch of scanned documents into separate documents. The workstation includes a display. The display provides a display of information for each document. The workstation has inputting apparatus responsive to operator identified portions of information to selectively scan and input the operator identified portions to obtain text based captured information from each document. The workstation utilizes the text based captured information to create an image file for each document and a text file for the batch. The text file comprises the text based captured information and references to each image file.

The document processing portion comprises a computer, memory, and a document processing program. The memory comprises a database and file storage. The document processing program runs on the computer and utilizes the text file to control loading of data relating to the documents into the database and control transfer of the image file for each document into one or both of the file storage and the database.

The document accessing portion comprises user terminals for accessing the database and the file storage to selectively access text based captured information and the document images.

In a method for providing electronic document management in accordance with the invention, a plurality of related documents is gathered. The documents are separated with separators to form a document batch. The entire document batch is scanned to produce electronic document images. The electronic document images are automatically separated and stored as electronic document images in a first directory. Document identifying information is created for each document as a text file and is saved in the first directory.

From the first directory each document image is transferred to and stored in a database. Likewise, each text file is stored in a second database. An automatic notification is provided to one or more predetermined users that each document image is stored in said the database.

In accordance with one aspect of the invention the system automatically provides the notification as an e-mail message to the one or more predetermined users.

In accordance with another aspect of the invention, the method includes providing in the e-mail message links to the document images and automatically providing the document images to a user in response to the user activating one of the links.

Still further in accordance with an aspect of the invention each text file is automatically checked against predetermined criteria and the document images are stored in a database only if the text file meets the predetermined criteria. Similarly each text file is stored in a second database only if the text file meets the predetermined criteria.

In the event that the text file does not meet the predetermined criteria an error indication is provided to a system administrator. The system administrator can attempt to correct the error by modifying the text file. Each document image is then stored in a database after said system administrator has modified said text file and each text file is stored in a second database.

In the event that the system administrator is unable to provide a correcting modification to the text file, document images and said text files are deleted from the directory and the document batch is rescanned and the process is repeated.

In accordance with another aspect of the invention a method for providing electronic document management includes gathering a plurality of related documents and separating the plurality of related documents with separators to form a document batch. The document batch is scanned to produce electronic document images. The electronic document images are automatically separated and stored in a first directory. Each document is displayed on a workstation display to a user. Document identifying information is created for each document in response to user indicated portions of each displayed document and is saved in a text file in the first directory.

In accordance with another aspect of the invention, the user indicated document identifying information is automatically converted to a uniform format.

### BRIEF DESCRIPTION OF THE DRAWING

The invention will be better understood from a reading of the following detailed description in conjunction with the drawing in which like reference designations are used in the various drawing figures to identify like elements, and in which:

FIG. 1 is a block diagram of a system in accordance with the invention;

FIG. 2 is a diagram illustrating a first portion of the system of FIG. 1 in accordance with one aspect of the invention;

FIG. 3 is a diagram illustrating a second portion of the system of FIG. 1 in accordance with the principles of the invention;

FIG. 4 is a diagram illustrating functional operation of a system in accordance with the invention;

FIG. 5 is a flow diagram of overall operation of the system of FIGS. 1-3; and

FIGS. 6-11 are each detailed flow diagram of a portion of the flow diagram of FIG. 5.

### DETAILED DESCRIPTION

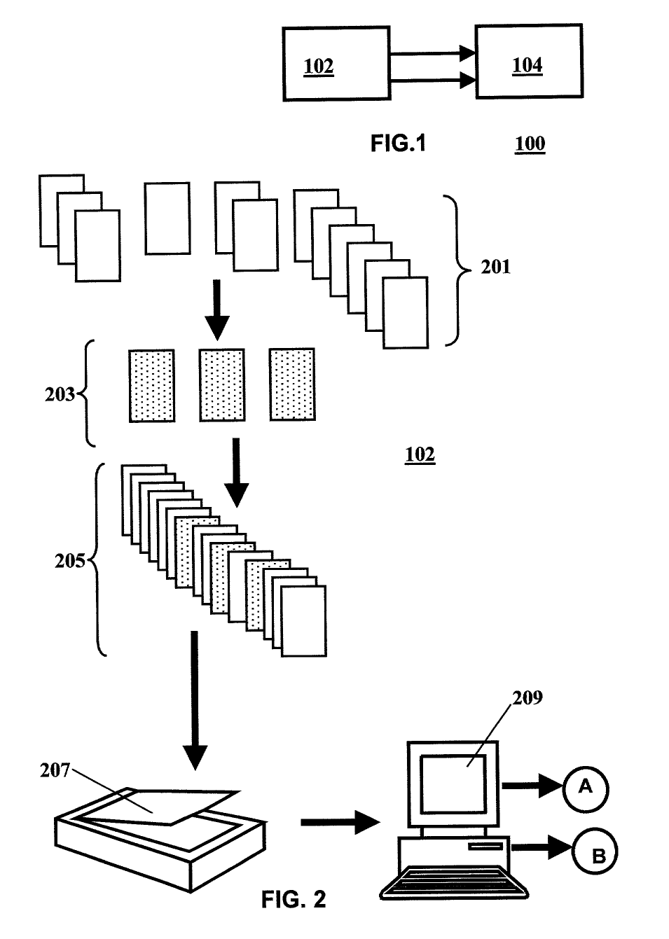

Turning now to FIG. 1, the document processing system 100 of the invention includes a document receiving portion 102 and a document processing and accessing portion 104. Documents that are received are processed in document receiving portion 102 to produce electronic document images and text files that are stored in one or more databases in document processing and accessing portion 102. Document processing and accessing portion 102 provides for notification of document availability and document accessibility.

FIG. 2 shows the document receiving portion 102 in greater detail. Documents 201 are received, by for example a law firm clerk assigned to a docketed matter. The clerk separates the documents 201 by inserting separator sheets 203 between the different documents 201 to form a single document batch 205. The separator sheets 203 are recognized by the scan processing software being run on workstations 209 so that the system automatically recognizes each separator sheet 203 as a break between two documents. The entire document batch 205 comprising documents and document separators are then loaded into a batch scanner 207. The entire document batch 205 is scanned consecutively without interruption, and the scanned results are stored in a directory or memory accessible by workstation 209. A full text optical character recognition software program is utilized in conjunction with batch scanner 207. Both document images and text files are produced. At workstation 209, each document is displayed to permit the clerk to classify each document according to predetermined criteria formatted in predefined fields or “tabs” representing folder tabs in a non-electronic filing system. The software program utilized produces an image file and a text file that is generated utilizing optical character recognition (OCR) software. In accordance with one aspect of the invention, as each document is displayed on the display of workstation 209 the clerk then “highlights” or otherwise indicates text belonging in a field or tab and “drags” the text to the field. The system software for example in a simple representative example utilizes three fields or tabs to identify the documents, e.g., document type, date of document, and document title. The software provides conversion of text to a uniform format. For example the software will recognize document dates in all conventional ways of writing dates and will standardize the date of the document. With this novel feature, the clerk does not have to retype the date into desired format and document processing is greatly speeded up. Workstation 209 transfers the image files and text files to the document processing and accessing portion 104.

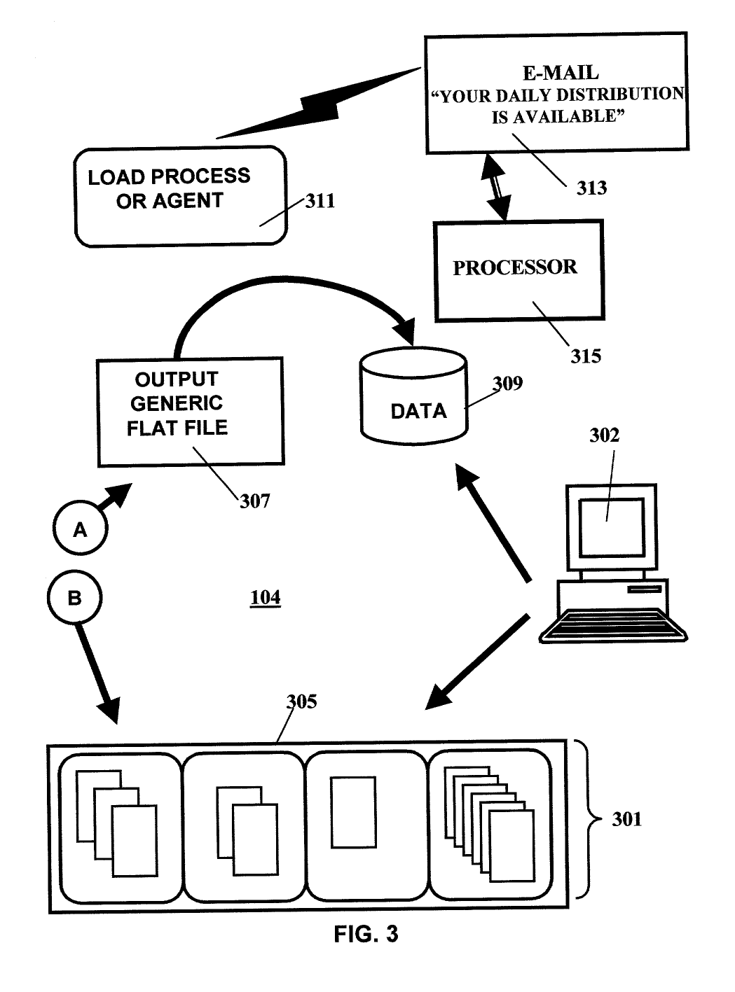

Turning now to FIG. 3, each document image 301 is “wrapped” within a particular image format and stored in a database 305 under control of a processor 302. In the illustrative embodiment of the invention, each document image is wrapped within the Adobe Acrobat™ PDF (Portable Document Format) image format file 303. Text files with coded data is stored as a generic flat file 307 in a database 309 by processor 302. The storing of the text files is done automatically under control of a load agent or program. Databases 305, 309 may be a single database memory and may be an existing database. Upon loading of documents in the system 100, system software 311 running on processor 302 generates an electronic mail or e-mail message 313 to a predetermined mail list that identifies each document added to the database. The e-mail message may include links to permit the reader of the email to “click” on a document identifier in the email message to permit substantially instant access to the document. A system user at a terminal 315 receives the e-mail and advantageously, this arrangement provides for quicker notification of the availability of documents that are scanned into the system and further provides for substantially instant retrieval of the documents for viewing. Although only one terminal 305 is shown, it will be understood by those skilled in the art that a plurality of terminals may be utilized. The plurality of terminals 305 may access the processing and accessing portion 104 via wired or wireless connections and may be part of a network of any kind including, but not limited to, a local area network, a wide area network, a virtual network or via Internet connections.

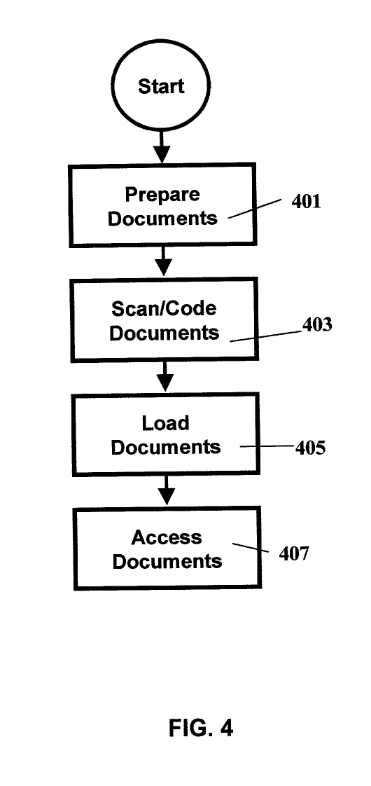

The operation of the system will now be explained in greater detail in conjunction with FIGS. 4 through 11, inclusive.

In FIG. 4, a system user, typically a clerk, gathers all documents that are similar, places separator sheets between documents to form a document batch and places the batch on a batch processing scanner. At step 403, the batch is scanned in as a batch rather than as individual documents. One advantageous key to high speed document processing is the use of batch scanning. Each document is also coded for identification and retrieval. At step 405 the scanned documents are loaded into the system databases and become available for access by anyone having networked access to the databases as indicated at step 407.

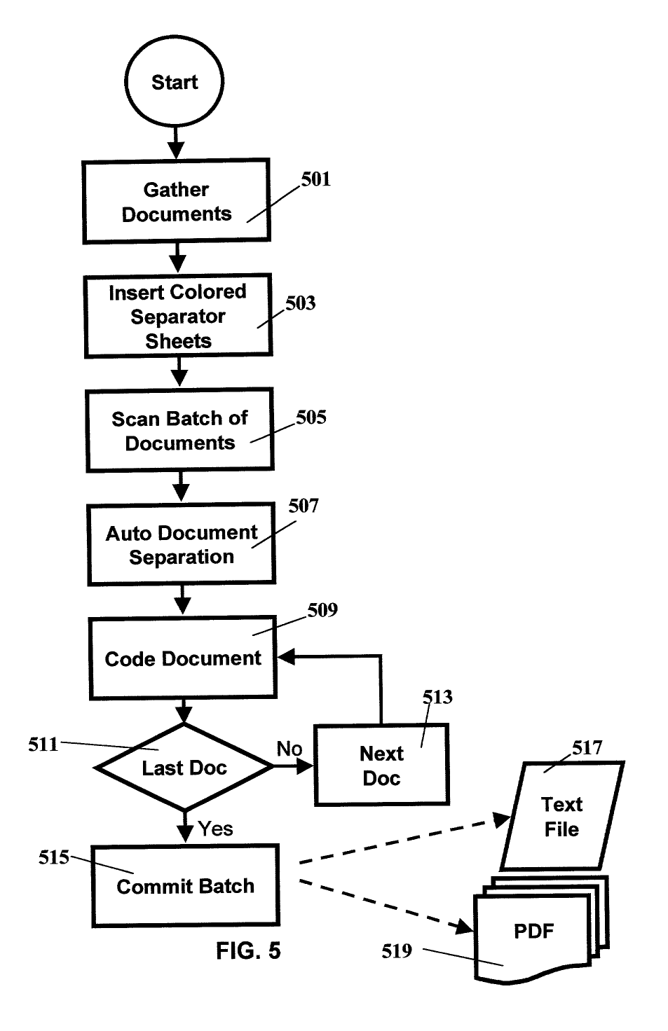

FIG. 5 illustrates the steps involved in scanning a batch of documents. As indicated at step 501, the documents to be scanned into the system are gathered. Separator sheets are inserted between the individual documents at step 503 to form a batch of documents. The stack of documents is scanned into the system at step 505. The system software recognizes the separator sheets and automatically separates the stack of documents into separate documents at step 507. The clerk the codes or identifies each document at step 509, by dragging the field data from the document and dropping it into the appropriate data fields. In the illustrative embodiment of the in invention up to twenty (20) fields may be accommodated including two mandatory fields: tab and file on link. At step 511, the system determines if the last document processed is not the last document in the batch. If the system determines that not all scanned documents have been processed, then at step 513, the next document in the batch is obtained and then coded at step 509. If the system determines that the last document has been scanned at step 511, system 100 at step 515 commits the batch to storage in the database by creating text files 517 an and PDF files 519. Text file 517 contains all coded document identifying information, file linking, and file name.

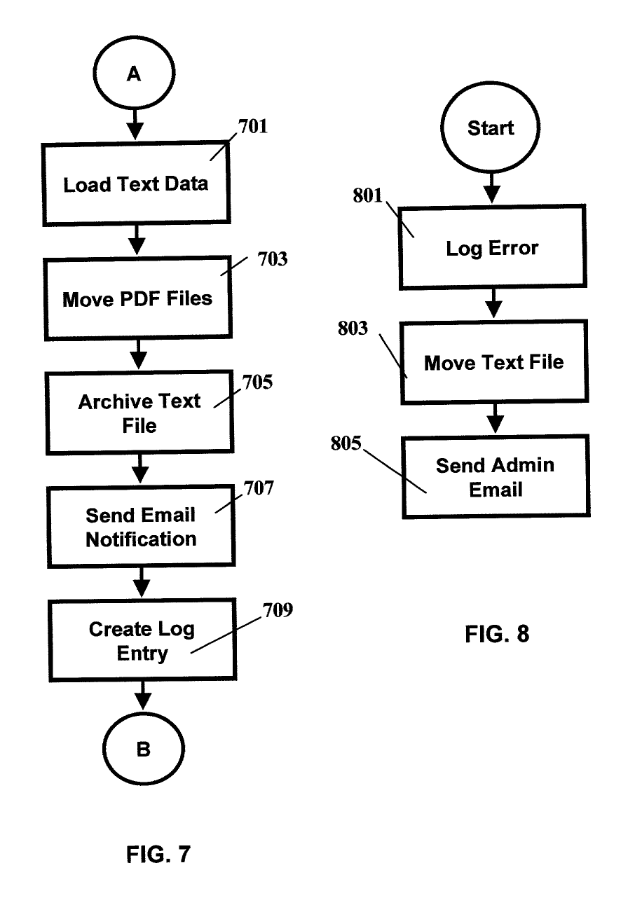

As each document is scanned in, a first program or agent views a directory at step 601 to determine if a new document file has been stored. If no new text file is identified, the agent times out or “sleeps” for a predetermined time period as indicated at step 603. In the illustrative embodiment of the invention the predetermined time period is five minutes. If at step 601 a new text file is identified the file name is parsed. By way of example, the format of the file name is “casename_date_time”. From the file name it is determined if a profile exists. If no profile exists, an error is defined and an error process step 609 is executed. If a profile exists as determined at step 607, the specifications for the specific case are obtained from memory. After the case specifications are obtained at step 611, agent 1 tests the records at step 613. At step 615, it is determined if the records past testing. If the records do not pass testing, an error process routine is executed as indicated at step 617. If the records pass testing at step 613, the system loads the text data into the database as shown in step 701 in FIG. 7. At step 703 the system moves the PDF files to a location in memory. At step 705 the text files are archived. By archiving text files, if the database becomes messed up, for example, the system still as all the data and all PDF files and can recover. At step 707, the system automatically sends an e-mail notification to all members of the case team that have been previously identified in the system. The email notification will identify that one or more new documents have been received and identify each document by predetermined fields such as tab number, date and title. At step 709 a log entry is created for system administration purposes. The log entry can for example indicate where the files are stored.

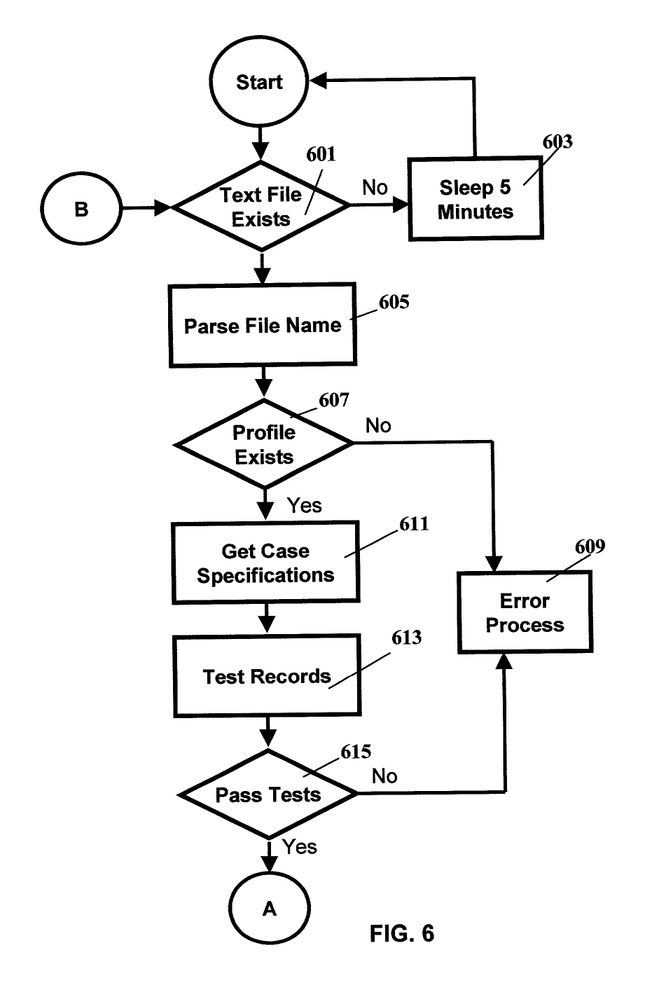

FIG. 8 illustrates the operation of the error process entered into from the flow operation shown in FIG. 6. When an error is detected in the document processing, the error is logged at step 801. The error log stores the date, time and file name associated with the error and includes a field to identify the error type or category. At step 803, the text file causing the error indication is moved to a “bad loads” directory to prevent the system agent or software from seeing the file having the error indication the next time that the system processes a batch of documents. At step 807, an e-mail is sent to a system administrator. The email contains the same information that is contained in the error log.

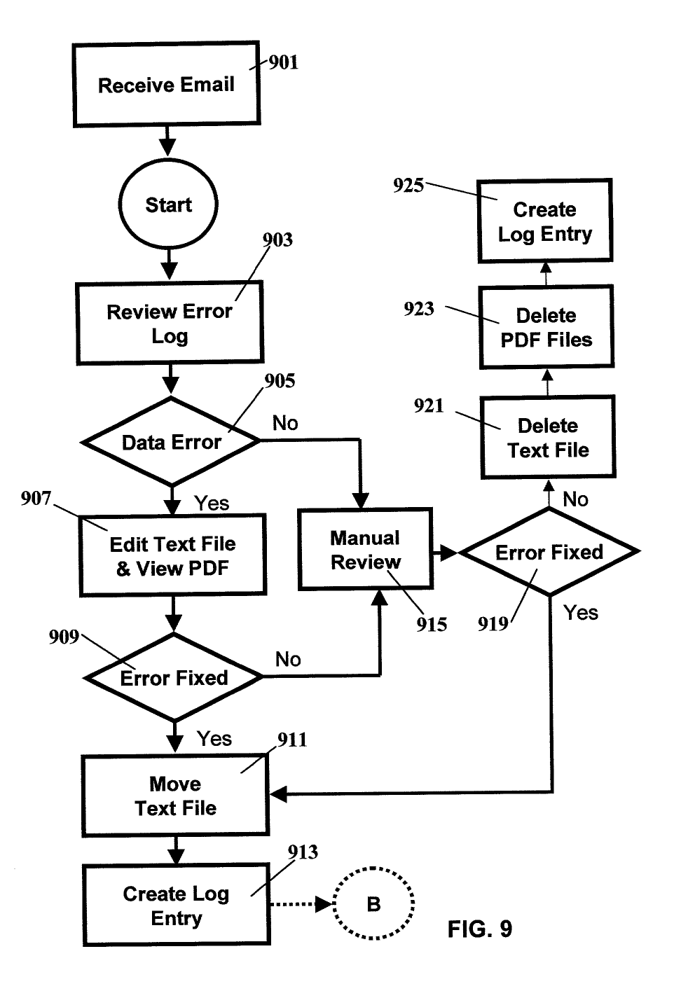

FIG. 9 illustrates the administrator's repair of errors. At step 901, the system administrator receives the emailed error message. The administrator may start the error repair process at any time. To start the error repair process, the administrator reviews obtains and reviews the error log at step 903. The administrator determines at step 905 whether the error is a data error, such as, for example, a missing data field. If the error is a data error, the administrator can open the text file and view the PDF image of the document to determine where the missing data is in the document as indicated at step 907. The administrator upon finding the missing data can “click and drag” the information into the data field or can manually enter the information into the data field to fix the error. If the administrator fixes the error at step 909, the administrator moves the text file from the bad file directory to a load directory at step 911, and a log entry is created at step 913. The document processing for this document then proceeds in accordance with the processing shown in FIG. 6.

If at step 905 it is determined that the error is not caused by a data error, or if the administrator cannot fix the error at step 909, manual review of the document scanned occurs at step 915. Examples of the error not being a data error or not being correctable are that the case does not exist in the system database, i.e., it is a new case or has been wrongly identified, or the PDF file does not exist. If after manual review, the administrator fixes the error, the next step is step 911 and the text file is moved from the bad file directory to the load directory. If, however, manual review did not result in the error being fixed at step 919, the text file is deleted at step 921 and the PDF file is deleted at step 923, and a log entry is created at step 925. At this point, the entire batch will be rescanned and reprocessed.

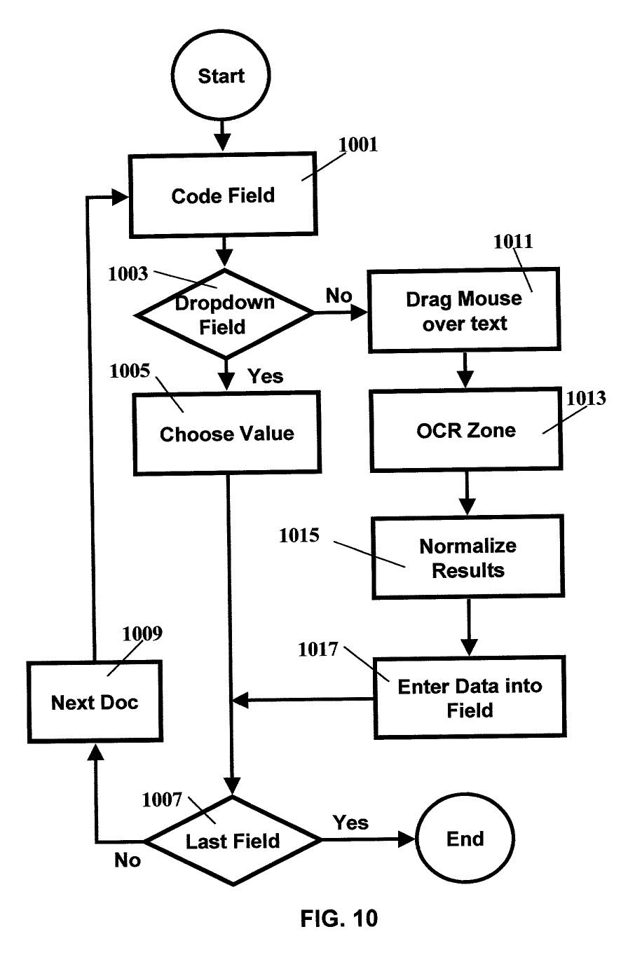

FIG. 10 illustrates the flow of coding documents that occurs at workstation 209 in FIG. 2. As each document OCR image is displayed on the screen of workstation 209, the system will automatically prompt the clerk that a document data field requires data entry or coding. In the illustrative embodiment of the invention, the prompt occurs by presenting the data field to be coded on the workstation display. Some of the data fields are dropdown fields and others are not. If at step 1003 it is determined that the data field is a dropdown field, a value is chosen for the field at step 1005. If the field is the last one of the document data fields for code entry, the coding will end as indicated at step 1007. If the document data field is not the last field, the system advances to the next field for code entry at step 1009 and the clerk is prompted to enter the next field at step 1001. If the field to be coded is not a dropdown field as indicated at step 1003, the clerk will then indicate the text portion of the document OCR image that contains the data to be coded into the document data field. In the illustrative system of the invention, the clerk drags a cursor over the text on the display and clicking as indicated at step 1011. The workstation automatically responds to the drag and click by identifying the zone indicated in the OCR document, and extracting the text as indicated at step 1013, normalizing the results at step 1015 and entering the data into the data field at step 1017. If the field in which the data is entered is the last data field, the coding is ended for the document. If the field in which the data is entered is not the last data field, the next filed is obtained at step 1009 and the process continues until all data fields are coded.

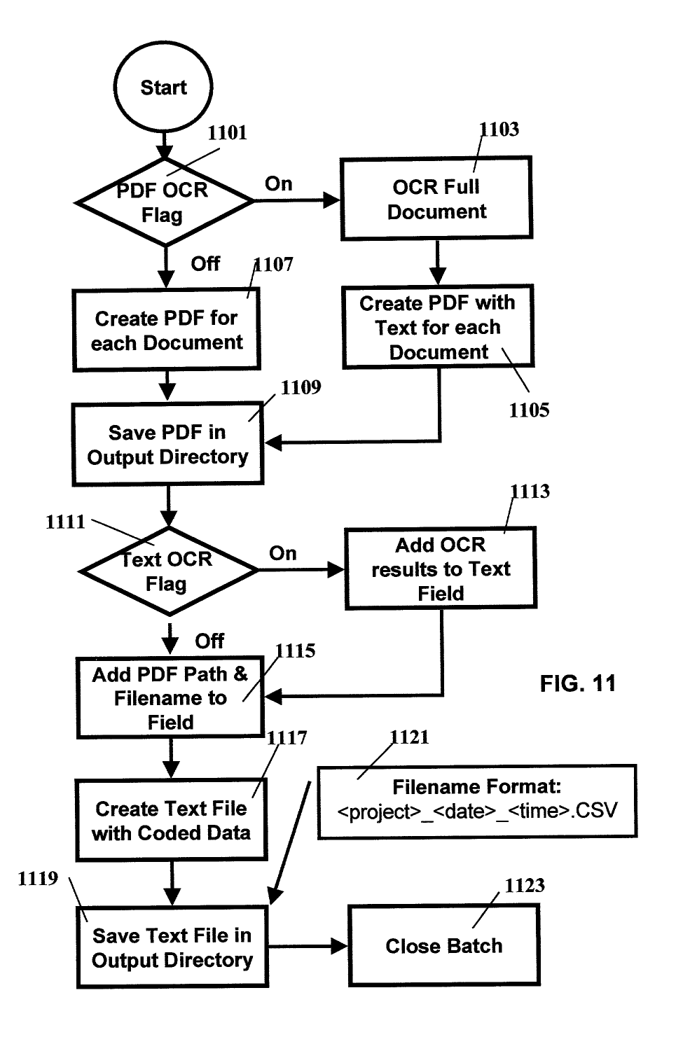

Turning now to FIG. 11, the processing of a document batch is shown in flow diagram format. At step 1101, a choice is made as to whether or not for each PDF image file a full text file should be created. If the PDF OCR flag is on, it is desired that there be a full text file for each PDF image file and the OCR program is utilized on the full scanned document at step 1103. The result is that a PDF image is created with text for each document as indicated at step 1105. The PDF image is saved in an output directory at step 1109. If the PDF OCR flag is off at step 1101, i.e., it is not necessary that a PDF file be provided that is full text, a PDF image is created for each document at step 1107. The resulting image is saved in the output directory at step 1109. At step 1111 the data fields are looked at to determine if a full text file is desired. If the flag is on, the OCR text results are added to the text field at step 1113 and the PDF Path and file name are added to the field at step 1115. Similarly, if the text OCR flag is off, the PDF path and file name are added to the data field. At step 1117, the text file is created with coded data. The text file is saved in the output directory at step 1119 and the filename format is illustrated at 1121. The batch is then closed at step 1123

As will be appreciated by those skilled in the art, various modifications can be made to the embodiments shown in the various drawing figures and described above without departing from the spirit or scope of the invention. It is intended that the invention include all such modifications. It is not intended that the invention be limited to the illustrative embodiments shown and described. It is intended that the invention be limited in scope only by the claims appended hereto.

What is claimed is:

1. An electronic document management system comprising:
a scanner, said scanner operable to receive a batch comprising a plurality of related documents, and a second plurality of document separators, each document separator being placed in said batch between document groupings, said scanner automatically scanning said batch and providing scan data for said batch;
a workstation, said workstation comprising a processor, a display, inputting apparatus and one or more first computer programs for operating said workstation; said workstation coupled to said scanner to receive said scan data for said batch, said one or more first computer programs causing said processor to recognize each said document separator; said one or more first computer programs causing said processor to display information represented by said scan data for each document separated by a corresponding said document separator from a next document; said one or more first computer programs being responsive to commands received from said inputting apparatus identifying selected portions of said information to obtain text based captured information for each said document, and said one or more first computer programs utilizing said text based capture information to cause said processor to create an image file for each said document and a corresponding text file for said batch, said text file comprising said text based captured information and references to each said document image file.

2. An electronic document management system in accordance with claim 1, comprising:
a document processing portion, comprising a processor, memory, and a document processing program;
said memory comprising a database for storing data related to each of said documents and a file storage for storing image files for each document;
said document processing program running on said processor to utilize each said text file to control storing of data relating to said documents into said database and controlling transfer of each said image file into one or both of said file storage and said database.

3. An electronic document management system in accordance with claim 2, wherein:
said document processing program automatically identifies errors in said text data prior to storing of said documents into said database, said document processing program causes said processor to produce an error indication when said errors are identified.

4. An electronic document management system in accordance with claim 3, comprising:
output apparatus for providing a document administrator with said error indications;
second inputting apparatus operable by said document administrator for correcting each said error indication, and
said document processing program responding to corrections of said error indication by causing said processor to store said text files and said image files.

5. An electronic document management system in accordance with claim 4, wherein:
said document processing software causes a notification to be sent to predetermined document management system users that documents identified by said text data are stored in said image files.

6. An electronic document management system in accordance with claim 5, comprising:
said notification is an e-mail message to said predetermined document management system users.

7. An electronic document management system in accordance with claim 6, wherein:
each said e-mail message comprises a link to each said document identified by said text data.

8. An electronic document management system in accordance with claim 7, comprising:
at least one document accessing terminal said at least one document accessing terminal receiving said email;
said at least one document accessing terminal operative to utilize said link to access said database and said file storage to selectively access text based captured information and said images.

9. An electronic document management system in accordance with claim 2, wherein:
said document processing software causes a notification to be sent to predetermined document management system users that documents identified by said text data are stored in said image files.

10. An electronic document management system in accordance with claim 9, comprising:
said notification is an e-mail message to said predetermined document management system users.

11. An electronic document management system in accordance with claim 10, wherein:
each said e-mail message comprises a link to each said document identified by said text data.

12. An electronic document management system comprising:
a document receiving system portion comprising a scanner and a first processor;
said scanner automatically scanning a batch of related documents separated into a plurality of document groupings;
said first processor operable to receive scan data from said scanner and automatically separating said batch of scanned documents into separate documents, said first processor operable to obtain text based captured information from each document, said first processor operable to utilize said text based captured information to create an image file for each document and a text file for said batch comprising said text based captured information and references to each said image file;
a document processing portion comprising a second processor, a memory, and a document processing program, said memory comprising a database and file storage, said document processing program running on said processor to utilize said text file to control loading of data relating to said documents into said database and to control transfer of said image file for each document into one or both of said file storage and said database.

13. An electronic document management system in accordance with claim 12, comprising:
a document accessing portion comprising apparatus to access said database and said file storage to selectively access text based captured information and said images.

14. A method for providing electronic document management, comprising:
gathering a plurality of related documents;
separating each of said plurality of related documents with separators to form a document batch;
scanning said document batch to produce electronic document images;
automatically separating each electronic document image;
storing each electronic document image in a first directory;
creating document identifying information for each document as a text file; and
saving said text file in said first directory.

15. A method for providing electronic document management in accordance with claim 14, comprising:
storing each said document image in a database;
storing each said text file in a second database; and
automatically providing a notification to one or more predetermined users of the storing of each said document image in said database.

16. A method for providing electronic document management in accordance with claim 15, comprising:
providing said notification as an e-mail message to said one or more predetermined users.

17. A method for providing electronic document management in accordance with claim 16, comprising:
providing in said e-mail message links to said document images; and
automatically providing said document images to said user in response to said user activating one of said links.

18. A method for providing electronic document management in accordance with claim 14, comprising:
automatically checking said text file against predetermined criteria;
storing each said document image in a database if said text file meets said predetermined criteria; and
storing each said text file in a second database if said text file meets said predetermined criteria.

19. A method for providing electronic document management in accordance with claim 18, comprising:
automatically providing a notification to one or more predetermined users of the storing of each said document image in said database.

20. A method for providing electronic document management in accordance with claim 19, comprising:
providing said notification as an e-mail message to said one or more predetermined users.

21. A method for providing electronic document management in accordance with claim 20, comprising:
providing in said e-mail message links to said document images; and
automatically providing said document images to said user in response to said user activating one of said links.

22. A method for providing electronic document management in accordance with claim 14, comprising:
automatically checking said text file against predetermined criteria;
automatically providing an error indication if said text file does not meet said predetermined criteria.

23. A method for providing electronic document management in accordance with claim 22, comprising:
providing said error indication to a system administrator;
allowing said system administrator to modify said text file;
storing each said document image in a database after said system administrator has modified said text file; and
storing each said text file in a second database after said system administrator has modified said text file.

24. A method for providing electronic document management in accordance with claim 22, comprising:
deleting said document images and said text files from said first directory; and
rescanning said document batch.

25. A method for providing electronic document management, comprising:
gathering a plurality of related documents;
separating each of said plurality of related documents with separators to form a document batch;
scanning said document batch to produce electronic document images;
automatically separating each electronic document image;
storing each electronic document image in a first directory;
displaying each document on a workstation display to a user;
creating document identifying information for each document in response to user indicated portions of each displayed document; and
saving said text file in said first directory.

26. A method for providing electronic document management in accordance with claim 25, comprising:
automatically converting said user indicated portions to a uniform format.
